(19) United States
(12) Patent Application Publication
(10) Pub. No.: US 2009/0201989 A1
(43) Pub. Date: Aug. 13, 2009

(54) Systems and Methods to Optimize Entropy Decoding

(76) Inventors: Sherjil Ahmed, Irvine, CA (US); Mohammed Usman, Mission Viejo, CA (US); Mohammad Ahmad, Irvine, CA (US)

Correspondence Address: PATENTMETRIX, 14252 CULVER DR. BOX 914, IRVINE, CA, 92604, US

(21) Appl. No.: 12/263,129

(22) Filed: Oct. 31, 2008

Related U.S. Application Data
(60) Provisional application No. 60/984,420, filed on Nov. 1, 2007.

(51) Int. Cl. H04N 7/12; H04N 7/26

(52) U.S. Cl. 375/240.08; 375/240.25; 375/E07.027; 375/E07.026

(57) ABSTRACT

The present invention provides for an improved video compression and encoding that optimizes and enhances the overall speed and efficiency of processing video data. In one embodiment, the video codec transmits the output of an entropy decoder to a lossless compressor and memory before going through inverse discrete cosine transformation and motion compensation blocks.

### CROSS-REFERENCE

The present invention relies on U.S. Provisional Application No. 60/984,420, filed on Nov. 1, 2007, for priority.

### FIELD OF THE INVENTION

The present invention relates generally to a video encoder and, more specifically, to a video codec that optimizes load balancing during data processing, provides efficient data fetching from memory storage and improves efficiency of access to adjoining pixel blocks that are used to predict the code block pattern of a target block/pixel.

### BACKGROUND OF THE INVENTION

Video compression and encoding typically comprises a series of processes such as motion estimation (ME), discrete cosine transformation (DCT), quantization (QT), inverse discrete cosine transform (IDCT), inverse quantization (IQT), de-blocking filter (DBF), and motion compensation (MC). These processing steps are computationally intensive thereby posing challenges in real-time implementation. At the same time contemporary media over packet communication devices, such as Media Gateways, are called upon to simultaneously process and transmit audio/visual media such as music, video, graphics and text. This requires substantial scalable media processing to enable efficient and quality media transmission over data networks.

One way of improving the speed of video processing is to employ parallel processing where each of the aforementioned processes of ME, DCT, QT, IDCT, etc. are performed, in parallel, on individual hardwired processing units or application specific DSPs. However, load balancing among such individual processing units is challenging often resulting in a waste of computing power.

Digital video signals, in non-compressed form, typically contain large amounts of data. However, the actual necessary information content is considerably smaller due to high temporal and spatial correlations. Accordingly, video compression or coding endeavors to reduce the amount of video data which is actually required for storage or transmission. More specifically, there may be pixels that do not contain any, or only slight, change from corresponding parts of the previous or adjacent pixels. With a successful prediction scheme, the prediction error can be minimized and the amount of information that has to be coded can be greatly reduced. Existing techniques suffer, however, from inefficient access to the blocks/pixels used to predict the code block pattern of a block/pixel.

Accordingly there is need for improved video compression and encoding that implements novel methods and systems to optimize and enhance the overall speed and efficiency of processing video data.

### SUMMARY OF THE INVENTION

It is an object of the present invention to optimize load balancing for the video codec.

Accordingly, one embodiment of the video codec of the present invention uses a lossless compressor between the entropy decoder and the inverse discrete cosine transformation block.

It is another object of the present invention to improve the efficiency of accessing data from memory by optimizing the overall number of memory data fetches. Such data fetches are required with reference to task scheduling in the video codec of the present invention.

It is also an object of the present invention to provide an optimized memory page size and format for accessing frames. In one embodiment, the storage memory is organized into pages of size 2 k bytes with a format that is 256 bits long by 16 bits wide. In another embodiment, memory is organized into pages of 2 k bytes in a format that is 128 bits long by 32 bits wide.

It is a yet another object of the present invention to improve access to adjoining pixel blocks that are used to predict the code block pattern of a target block/pixel. Accordingly, in one embodiment, a video codec of the present invention uses a vertical and horizontal array of data registers to store and provide the latest calculated values of the blocks/pixels to the top and left of the target block/pixel.

In one embodiment, the present invention comprises a processing pipeline for balancing a processing load for an entropy decoder of a video processing unit, comprising an entropy decoder having an input and an output, a lossless compressor having an output and an input in direct data communication with the output of the entropy decoder, a first memory having an output and an input in direct data communication with the output of the lossless compressor, an inverse discrete cosine transformation block having an output and an input in direct data communication with the output of the memory, and a motion compensation block having an output and an input in direct data communication with the output of the inverse discrete cosine transformation.

Optionally, the lossless compressor is a run length Huffman variable length coder or Lempel-Ziv coder. Optionally, the processing pipeline comprises a second memory having an output and an input in direct data communication with the output of the motion compensation block and a deblocking filter having an output and an input in direct data communication with the output of the motion compensation block.

Optionally, the first memory is organized into pages of size 2 k bytes with a format that is 256 bits long by 16 bits wide or pages of 2 k bytes in a format that is 128 bits long by 32 bits wide. Optionally, the second memory is organized into pages of size 2 k bytes with a format that is 256 bits long by 16 bits wide or pages of 2 k bytes in a format that is 128 bits long by 32 bits wide. Optionally, the first or second memory is organized as a matrix of values, wherein said matrix has vertical values and horizontal values. Optionally, the system comprises four hardware registers for storing said vertical values or four hardware registers for storing said horizontal values.

In another embodiment, the present invention comprises a processing pipeline for balancing a processing load for an entropy decoder of a video processing unit, comprising an entropy decoder having an input and an output, a lossless compressor having an output and an input in direct data communication with the output of the entropy decoder wherein no other processing unit is present between said entropy decoder and said lossless compressor, a first memory having an output and an input in direct data communication with the output of the lossless compressor, wherein no other processing unit is present between said lossless compressor and memory, and an inverse discrete cosine transformation block having an output and an input in direct data communication with the output of the memory, wherein no other processing unit is present between said memory and inverse discrete cosine transformation block. Optionally, data is communicated from an entropy decoder to a lossless compressor to a memory without any intervention by another processing unit or block.

### BRIEF DESCRIPTION OF THE DRAWINGS

These and other features and advantages of the present invention will be appreciated as they become better understood by reference to the following Detailed Description when considered in connection with the accompanying drawings, wherein:

FIG. 1a shows a block diagram of one embodiment of a video processing unit (codec);

FIG. 1b shows block diagram of another embodiment of a video processing unit of the present invention; and

FIG. 2 shows a block diagram depicting a memory management scheme of the present invention in hardware.

### DETAILED DESCRIPTION OF THE INVENTION

The present invention will presently be described with reference to the aforementioned drawings. Headers will be used for purposes of clarity and are not meant to limit or otherwise restrict the disclosures made herein. Where arrows are utilized in the drawings, it would be appreciated by one of ordinary skill in the art that the arrows represent the interconnection of elements and/or components via buses or any other type of communication channel.

The novel systems and methods of the present invention are directed towards improving the efficiency of computationally intensive video signal processing in media processing devices such as media gateways, communication devices, any form of computing device, such as a notebook computer, laptop computer, DVD player or recorder, set-top box, television, satellite receiver, desktop personal computer, digital camera, video camera, mobile phone, or personal data assistant.

In one embodiment, the systems and methods of the present invention are advantageously implemented in media over packet communication devices (e.g., Media Gateways) that require substantial scalable processing power. In one embodiment, the media over packet communication device comprises media processing unit, designed to enable the processing and communication of video and graphics using a single integrated processing chip for all visual media. One such media gateway and media processing device has been described in application Ser. No. 11/813,519, entitled “Integrated Architecture for the Unified Processing of Visual Media”, which is hereby incorporated by reference. It should be appreciated that the processing blocks, and improvements described herein, can be implemented in each of the processing layers, in a parallel fashion, in the overall chip architecture.

Video processing units or codecs implement a plurality of processing blocks such as motion estimation (ME), discrete cosine transformation (DCT), quantization (QT), inverse discrete cosine transform (IDCT), inverse quantization (IQT), de-blocking filter (DBF), and motion compensation (MC). The intensive computation involved in these processing blocks poses challenges to real-time implementation. Therefore, parallel processing is employed to achieve necessary speed for video encoding where each of the aforementioned processing blocks are implemented as individual hardwired units or application specific DSPs. Thus, the DCT, QT, IDCT, IQT, and DBF are hardwired blocks because these functions do not vary substantially from one codec standard to another. Such parallel processing is described in U.S. patent application Ser. No. 11/813,519, which is incorporated by reference.

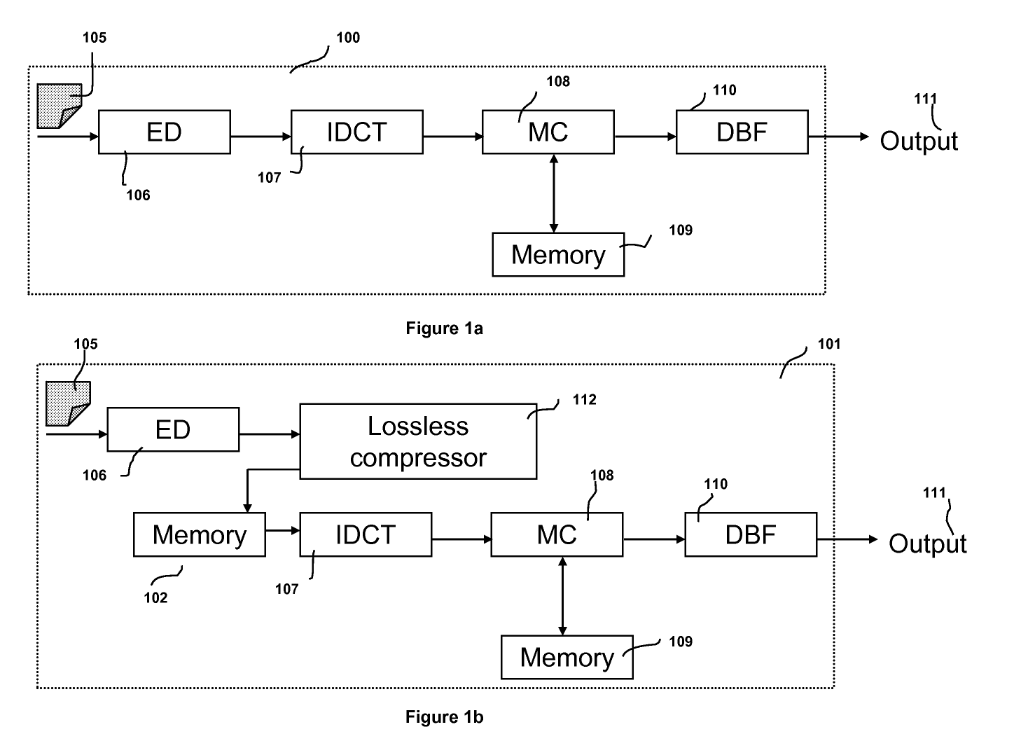

However, load balancing among such individual processing blocks is challenging because of the data dependent nature of video processing. Imbalance in load results in a waste of computing power. Thus, according to one aspect of the present invention a lossless compressor block is used to optimize load balancing in video processing. FIG. 1a shows block diagram of a video processing unit (codec) 100. A macro-block 105 is subjected to processing through an entropy decoder (ED) 106, then sent through an inverse discrete cosine transformation block (IDCT) 107 and then through motion compensation block (MC) 108. The motion compensation block 108 calls on memory 109 for required data useful in determining motion compensation as known to persons of ordinary skill in the art. The output of the MC block 108 is optionally sent through a deblocking filter (DBF) 110 and then transmitted out as bit stream output 111. The output of the MC block 108 is also sent to memory 109 for future MC calculations.

Video codec 100, however, is not optimized for load balancing. For all blocks except the ED 106, the load balance is relatively easy to do and predictable Specifically, except for the ED 106 block, all the other processing engines have predictable processing times for I, P and B frames and therefore, load balancing among them, which are connected in a pipelined fashion, can easily be achieved. But ED 106, which is connected in the same pipeline, has a variable processing time. Therefore, the rest of the engines could be stalled when ED 106 is busy decoding higher bit rate frames/macro blocks.

To solve this problem, as shown in FIG. 1b, ED is disconnected from the pipeline and connected to the memory 102, which can be the same as or separate from memory 109, and allowed to operate at its own processing speed without affecting the rest of the engines. This effectively makes ED as a single processing element in its own pipeline.

Additionally, to avoid the extra data traffic to and from memory, a lossless compressor is deployed at the output of ED to reduce the amount of data to be stored in the memory. For example, decoding can be performed at the rate of 100 bits/sec. However, for ED, decoding at 100 bits/sec can be challenging. To address the issue of load balancing, the video codec 101 of the present invention uses a lossless compressor 112 between ED 106 and IDCT 107 as shown in FIG. 1b. Thus, according to an aspect of the present invention, data output from the ED 106, which is typically twice the size of a frame, is sent through a lossless compressor 112, such as a run length Huffman variable length coder (VLC), Lempel-Ziv coder or any other variable-length coder (VLC) known to persons of ordinary skill in the art. The VLC 112 encodes data to about 15-20% of the size of a frame and then decodes as required. Since this intermediate encoding 112, using a VLC, is neither too complex nor penalizes the overall bandwidth, it enables efficient load balancing in the present invention. The VLC unit 112 preferably encodes the frame data using a syntax that includes the type of macroblock, motion vector data, prediction error data, and residual data.

Accordingly, referring to FIG. 1b, a macro-block 105 is subjected to processing through an entropy decoder 106, compressed using a lossless compressor 112, saved in a memory 102, then sent through an inverse discrete cosine transformation block (IDCT) 107 and then through motion compensation block (MC) 108. The motion compensation block 108 calls on memory 109 for required data useful in determining motion compensation as known to persons of ordinary skill in the art. The output of the MC block 108 is optionally sent through a deblocking filter (DBF) 110 and then transmitted out as bit stream output 111. The output of the MC block 108 is also sent to memory 109 for future MC calculations.

Persons of ordinary skill in the art would appreciate that video processing unit or codec 101 of the present invention is in data communication with external data and program memories, as disclosed in greater detail in U.S. patent application Ser. No. 11/813,519. A control engine (not shown) schedules tasks in the codec 101 for which it initiates a data fetch from external memory. The task contains information about the pointers for the reference and the current frames in the external memory. The control engine uses this information to compute the pointers for each region of data that is currently being processed and the data size to be fetched. It saves the corresponding information in its internal data memory. The data that is fetched is usually in chunks to improve the external memory efficiency. Each chunk contains data for multiple macro blocks.

Since the steps involved in video processing are very computationally intensive, data accessing from memory storage is required to be as efficient as possible. The present invention achieves more efficient data accessing by enabling a memory bus to access memory storage under a fast page mode. As known to persons of ordinary skill in the art, a page is a fixed length block of memory that is used as a unit of transfer to and from electronic storage memories. Thus, if data required for a single processing cycle is stored in ‘n’ different pages, where ‘n’>1, it can be inefficient to fetch the data and require splitting up the processing among several cycles. For example, if data is stored in 4 pages it would be required to perform 4 different page accesses. Each time a page is accessed it results in some time lost.

The present invention provides an optimized memory page size and format for accessing frames, organized in the form of block sizes, such as a 16×16 block, more rapidly. The optimized memory page size and format minimizes the number of memory page boundaries crossed during the access of a typical frame, thereby increasing the efficiency of memory access by reducing the overhead cost associated with initial accesses of memories under page access mode. In one embodiment, the storage memory is organized into pages of size 2 k bytes with a format that is 256 bits long by 16 bits wide. In another embodiment, memory is organized into pages of 2 k bytes in a format that is 128 bits long by 32 bits wide. These page formats minimize the number of required page accesses.

A set of video frames have great spatial redundancy as an inherent characteristic. This redundancy exists among blocks inside a frame and between frames. According to prior art block coding techniques, predictions are made to determine whether data for a particular block should be transmitted (i.e. code block pattern equal to 1) or need not be transmitted (i.e. code block pattern equal to 0). One of ordinary skill in the art would appreciate how, using prior art techniques, to calculate a predication state of a block using blocks to the left and top of that block (i.e. if value equals 0, then the code block pattern is predicted to be 0; if value equals 1, then the code block pattern is predicted to be unknown; if value equals 2, then the code block pattern is predicted to be 1).

Existing techniques suffer, however, from inefficient access to the blocks and memory management techniques. Preferably, a hardware implementation of the present invention further includes a memory management technique to more efficiently access blocks needed to do certain types of processing, such as motion estimation or motion compensation.

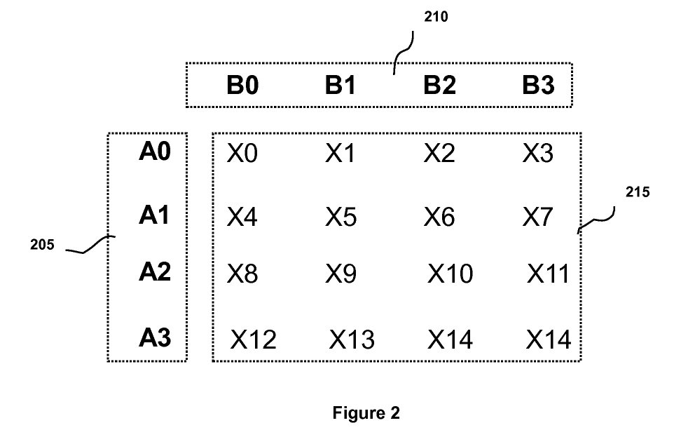

FIG. 2 shows a block diagram depicting implementation of the memory management method of the present invention in hardware. In an exemplary calculation, values of the pixels to the top and the left of the target pixel are needed. Typically, data in the vertical section is accessed in multiple clock cycles, slowing down performance. In the present invention, however, data access can be performed in fewer clock cycles, even a single clock cycle, thereby improving performance.

In a preferred approach, assume a data block contains a 4×4 set of blocks 215 depicted by notations X0 through X14. To improve the efficiency of accessing the value of neighboring pixels, a set of 4 hardware registers 205 in the vertical direction, denoted as A0 to A3, and another set of 4 hardware registers 210 in the horizontal direction, denoted as B0 to B3, are used to store required block values, in accordance with the method disclosed below.

To calculate the value of blocks X0 to X3, hardware registers A0 and B0 to B3 are used. To begin with, the values of A0 to A3 and B0 to B3 are derived from the neighboring blocks. To calculate X0, values in hardware registers A0 and B0 are used. Once X0 is calculated, the value of hardware registers A0 and B0 are replaced/over-written with value of X0. Similarly, to calculate value of block X1, values in hardware registers A0 and B1 are used. Once X1 is calculated, the value of B1 and A0 is replaced with X1. This process is repeated for X2 (uses B2 and A0 to calculate and replaces B2 and A0 with X2 value) and X3 (uses B3 and A0 to calculate and replaces B3 and A0 with X3 value). The same concept is repeated for each line. Block X4 uses values in hardware registers A1 and B0 (which is now X0). X5 uses A1 (which is now X4) and B1 (which is now X1). This way the hardware access for each value is fast and simple.

Persons of ordinary skill in the art should appreciate that when each X(n) is calculated and then hardware registers A and B are replaced with the calculated value, this results in an automatic usage of right values (top block and left block) whenever the value of the next block is calculated. In this manner, access to the requisite block values is optimized and made highly efficient.

It should be appreciated that the present invention has been described with respect to specific embodiments, but is not limited thereto. Although described above in connection with particular embodiments of the present invention, it should be understood the descriptions of the embodiments are illustrative of the invention and are not intended to be limiting. Various modifications and applications may occur to those skilled in the art without departing from the true spirit and scope of the invention as defined in the appended claims.

1. A system on a chip having a plurality of processing units in a pipeline, comprising:
an entropy decoder having an input and an output;
a lossless compressor having an output and an input in direct data communication with the output of the entropy decoder;
a first memory having an output and an input in direct data communication with the output of the lossless compressor;
an inverse discrete cosine transformation block having an output and an input in direct data communication with the output of the memory; and
a motion compensation block having an output and an input in direct data communication with the output of the inverse discrete cosine transformation.

2. The system of claim 1 wherein the lossless compressor is a run length Huffman variable length coder.

3. The system of claim 1 wherein the lossless compressor is a Lempel-Ziv coder.

4. The system of claim 1 further comprising a second memory having an output and an input in direct data communication with the output of the motion compensation block.

5. The system of claim 1 further comprising a deblocking filter having an output and an input in direct data communication with the output of the motion compensation block.

6. The system of claim 1 wherein the first memory is organized into pages of size 2 k bytes with a format that is 256 bits long by 16 bits wide.

7. The system of claim 1 wherein the first memory is organized into pages of 2 k bytes in a format that is 128 bits long by 32 bits wide.

8. The system of claim 4 wherein the second memory is organized into pages of size 2 k bytes with a format that is 256 bits long by 16 bits wide.

9. The system of claim 4 wherein the second memory is organized into pages of 2 k bytes in a format that is 128 bits long by 32 bits wide.

10. The system of claim 4 wherein said first or second memory are organized as a matrix of values, wherein said matrix has vertical values and horizontal values.

11. The system of claim 10 further comprising four hardware registers for storing said vertical values.

12. The system of claim 10 further comprising four hardware registers for storing said horizontal values.

13. A system on a chip having a plurality of processing units in a pipeline, comprising:
an entropy decoder having an input and an output;
a lossless compressor having an output and an input in direct data communication with the output of the entropy decoder wherein no other processing unit is present between said entropy decoder and said lossless compressor;
a first memory having an output and an input in direct data communication with the output of the lossless compressor, wherein no other processing unit is present between said lossless compressor and memory; and
an inverse discrete cosine transformation block having an output and an input in direct data communication with the output of the memory, wherein no other processing unit is present between said memory and inverse discrete cosine transformation block.

14. The system of claim 14 wherein the lossless compressor is a run length Huffman variable length coder.

15. The system of claim 14 wherein the lossless compressor is a Lempel-Ziv coder.

16. The system of claim 14 further comprising a second memory having an output and an input in direct data communication with the output of the motion compensation block.

17. The system of claim 14 further comprising a deblocking filter having an output and an input in direct data communication with the output of the motion compensation block.

18. The system of claim 14 wherein the first memory is organized into pages of size 2 k bytes with a format that is 256 bits long by 16 bits wide.

19. The system of claim 14 wherein the first memory is organized into pages of 2 k bytes in a format that is 128 bits long by 32 bits wide.

20. The system of claim 16 wherein the second memory is organized into pages of size 2 k bytes with a format that is 256 bits long by 16 bits wide.
